(19) United States
(12) Patent Application Publication
(10) Pub. No.: US 2013/0145350 A1
(43) Pub. Date: Jun. 6, 2013

(54) EFFICIENT, LARGE SCALE TRACE STORAGE SYSTEM

(71) Applicant: Adrian Marinescu, Issaquah, WA (US)

(72) Inventor: Adrian Marinescu, Issaquah, WA (US)

(73) Assignee: MICROSOFT CORPORATION, Redmond, WA (US)

(21) Appl. No.: 13/310,997

(22) Filed: Dec. 5, 2011

(51) Int. Cl. G06F 9/44; G06F 17/30

(52) U.S. Cl. 717/128; 707/737; 707/689; 707/E17.044

(57) ABSTRACT

A diagnostic system includes one or more processors for executing machine-executable instructions and one or more machine-readable storage media for storing the machine-executable instructions. The instructions include a plurality of traces. Each trace is a trace of events executing on a computing system. The system also includes processing logic configured to partition data in the trace into a first trace independent component which includes trace-independent information and a second trace dependent component which includes trace instance information. The system further includes a memory for storing the first trace independent component in a first data structure and the second trace dependent component in a second data structure.

### BACKGROUND

As application development projects are growing larger, tracing is becoming increasingly important. Tracing can be a very useful diagnostic tool used primarily by software developers to isolate problems, for example, by tracking execution of program code. For example, when developing an application, developers trace the execution of methods or functions within certain modules to identify problems and/or to determine if the program code may be improved. When such a problem or error is encountered, trace logs are analyzed to correlate trace messages with the application code to determine the sequence, origin, and effects of different events in the systems and how they impact each other. This process allows analysis/diagnoses of unexpected behavior or programming errors that cause problems in the application code.

Trace tools are generally application programs which use different techniques to trace the execution flows for an executing program. One technique, referred to as event-based profiling, tracks particular sequences of instructions by recording application-generated events as they occur. By way of example, a trace tool may record each entry into, and each exit from, a module, subroutine, function, method, or system component within a trace log (e.g., a time-stamped entry may be recorded within the trace log for each such event). Trace events may be sent to an output destination for subsequent analysis.

Often times, however, tracing can generate a very large amount of data (e.g., hundreds of MBytes to GBytes) in the trace logs, even in binary form. The storage and analysis of these traces is very challenging due to their size. In such a case, to simply use a text editor to open, view, and analyze the data in the trace logs may be difficult. In some cases, the amount of data is so large that a conventional text editor cannot even open it. Although the trace logs compress reasonably well with conventional algorithms, they nevertheless may remain large and require a significant amount of time to access since the compressed logged would require intermediate decompression steps.

### SUMMARY

In one implementation, a mechanism is provided to analyze and leverage the redundancy that is found across multiple traces. In particular, the data in each trace is divided into two parts. One part only includes trace-independent data (i.e., trace data that may be found in many traces and is not specific to only a single trace) such as event names, process names associated with events, stack traces, file names or generic trace invariant primitives. The second part of the trace data is trace-dependent information, which includes specific values that change from trace to trace. Examples of trace-dependent information include process IDs (PIDs), thread IDs, timestamps, wait times, IO times and so on. The trace-dependent information can be represented in an efficient manner by expressing trace-dependent data records in terms of the entries in the data structure storing the trace-independent data. Since in this way trace-independent data does not need to be included in each and every trace instance, redundancy in the trace data can reduced.

In another implementation, additional increases in efficiency can be achieved by only storing trace data that is likely to particularly useful. For instance, when multiple traces are examined, various patterns sometimes emerge which are likely to appear in future traces. Such patterns may include, for instance, a particular sequence of events which recurs in multiple traces or a common value for a particular property in one event that is found in another event within the same trace. When a pattern or sequence is found in multiple traces, the portion of the pattern which is invariant to any trace instance can be stored as trace-independent data and the trace specific information associated with the pattern can be stored as trace-dependent data. Other information associated with the traces may be optionally eliminated or stored as desired.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram depicting an illustrative computing environment used to obtain in performance traces of processes in a data processing system.

FIG. 2 is a diagram depicting various phases in obtaining a performance trace of the processes running on a subject machine.

FIG. 3 is a pictorial diagram showing portions of an illustrative event log.

FIG. 4 is a simplified functional block diagram of an illustrative computing platform or other electronic device incorporating the event tracing component shown in FIG. 1.

FIG. 5 is flowchart showing one example of a method for creating and storing trace data.

### DETAILED DESCRIPTION

Generally, tracing may cause a very large amount of data to be collected within a trace log or within multiple trace logs as well as from multiple executions of a scenario and ad-hoc trace collections on the same machine. In such a case, to analyze the trace log(s) from the beginning of the log(s) to the end may be burdensome and inefficient. This inefficiency is further exasperated by the circumstance of having to analyze and correlate several trace logs together for interrelated operations, and their resultant traces, that occur across multiple or parallel network nodes. To help alleviate the burden, a mechanism is described herein to analyze and leverage the redundancy across multiple traces. As detailed below, this mechanism partitions large traces into two components: a) a common knowledge dictionary containing synthetic events and basic primitives, which are invariant to trace instances and can be shared and leveraged across multiple traces, and b) specific data which uses the dictionary to efficiently represent the actual instances of traces.

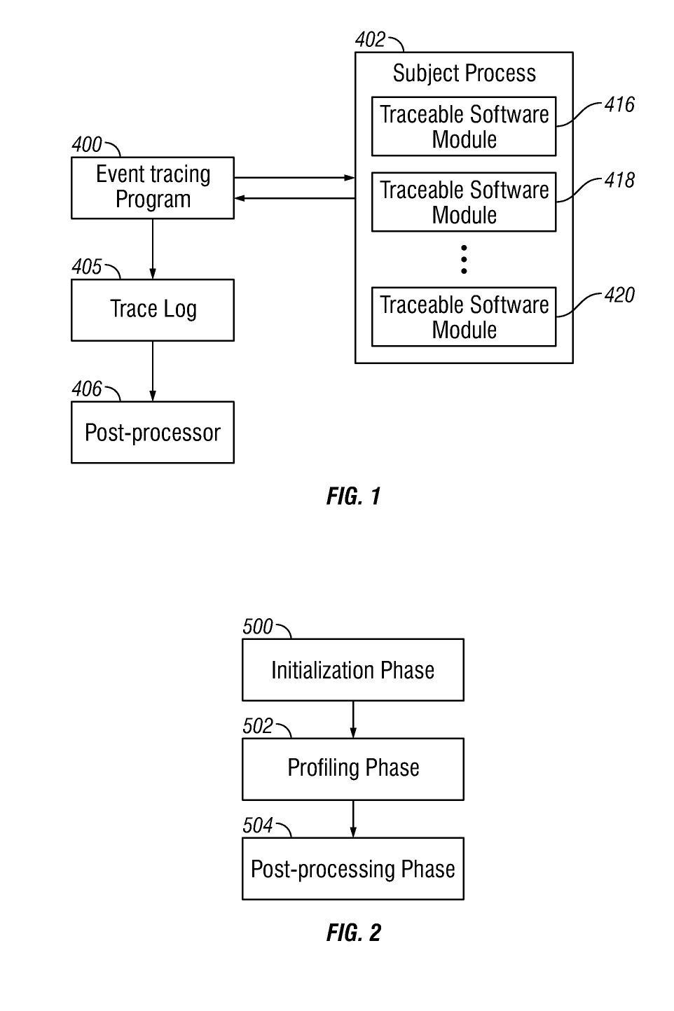

With reference now to FIG. 1, a block diagram depicts an illustrative computing environment used to obtain performance traces of processes in a data processing system. An event tracing component 400 (e.g., program) is used to record events occurring on a subject machine 402. The subject machine 402 in this example executes a plurality of traceable software modules 416-420. As their name indicates, each software module of the subject machine 402 is susceptible to event tracing. Of course, those skilled in the art will appreciate that in a deployed system other software modules which are not part of the subject machine 402 may also be concurrently operating, and depending on the event tracing mechanism used, may also be traced such that their actions are recorded by the event tracing component 400 in the trace log 405.

It should be noted that the components of the illustrative computing environment 400, while illustrated as entirely located on a single computer, may be distributed among a plurality of computers in any number of configurations. For instance, the event tracing component 400 may be located on one machine (e.g., a computer system) and used to record events that are executed on another machine.

In one embodiment, the components of the subject machine 402 may be susceptible to event tracing by virtue of being instrumented for tracing. In other words, special codes or a series of codes may be inserted in the components of the subject process that enable and facilitate event tracing. The inserted codes may perform the tracing themselves, or alternatively, act as a signal to another component to issue a notice of the event. Alternatively, event tracing may be enabled on the computer system due to the abilities of the operating system operating on the computer, including an operating system component specifically designed for event tracing. For example, Microsoft Corporation provides event tracing (called Event Tracing for Windows®, or ETW) on several of its Windows® operating systems. Similarly, other operating systems may also provide event tracing capabilities. As yet another alternative, an event tracing module installed on a computer system to listen for and detect the events on the computer system may be used in event tracing. Accordingly, while the components of the subject machine 402 should be susceptible to event tracing, the mechanisms described herein should not be construed as limited to any particular event tracing mechanism.

With reference now to FIG. 2, a diagram depicts various phases in obtaining a performance trace of the processes running on a subject machine. Subject to memory constraints, the generated trace output may be as long and as detailed as the analyst requires for the purpose of profiling a particular program. An initialization phase 500 is used to capture the state of the subject machine at the time tracing is initiated. This trace initialization data may include, for instance, trace records that identify all existing threads, all loaded modules, and all methods for the loaded modules. Records from trace data may be written to indicate thread switches, interrupts, and loading and unloading of modules and so on.

Next, during the profiling phase 502, trace records are written to a trace buffer or trace log. By way of example, the following operations may occur during the profiling phase if the user of the event tracing component 400 has requested sample-based profiling information. Each time a particular type of timer interrupt occurs, a trace record is written, which indicates the system program counter. This system program counter may be used to identify the routine that is interrupted. In one example, a timer interrupt is used to initiate gathering of trace data. Of course, other types of interrupts may be used other than timer interrupts. Interrupts based on a programmed performance monitor event or other types of periodic events may be employed, for example.

In the post-processing phase 504, the data collected in the trace buffer or log is sent to a post-processor 406 for post-processing. Depending on available resources, the trace log may undergo post-processing on the subject machine itself or on a separate machine such as a server or the like. Post-processor 406 will be used to execute the event tracing component 400 of FIG. 1.

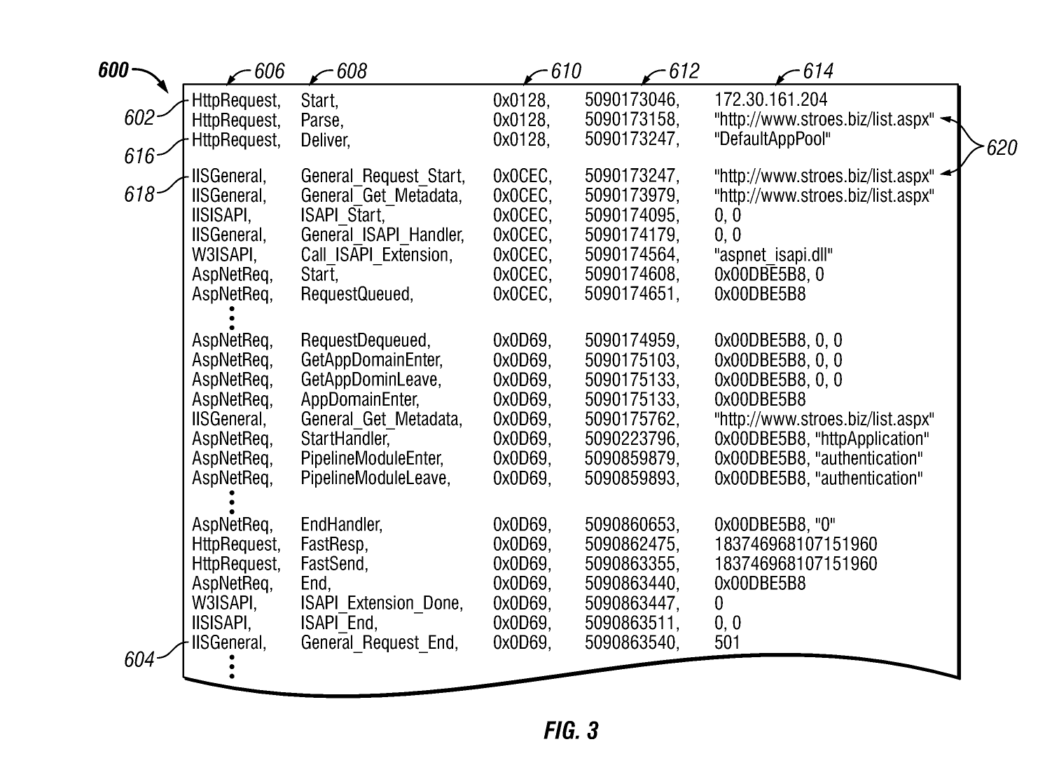

FIG. 3 is a pictorial diagram showing portions of an illustrative event log 600. The event log is typically formatted according to a predetermined schema. While only five columns/fields of information are displayed in the illustrative event log 600, it should be appreciated that other fields of information may be included as well. Thus, it should be appreciated that the entries in the event log 600 are for illustration purposes only, and may or may not reflect actual events in a process. Moreover, for convenience the illustrative events are shown in human-readable form. More generally, the events may be expressed using any suitable representation, including, for example, binary form.

As shown in the particular event log 600, the illustrative fields of the event log include fields for a general event classification (e.g., an event name) 606, an optional sub-classification 608, a process thread identifier 610, and a timestamp 612. The events will generally include additional properties, such as represented by field 614, will vary from event to event. Moreover, the total number of properties associated with each event is in general event-specific. For instance, two different types of events that may be found in a Windows® EWL are the Ready Thread and Context Switch events. The Ready Thread is logged by the kernel when a thread is waking up another thread by signaling an event for instance. The Context Switch event is logged when the scheduler switches the execution from one thread to another. The names of these two events are listed below, followed by illustrative examples of their respective properties (which may or may not all be found associated with an actual event):

ReadyThread, TimeStamp, Process Name (PID), ThreadID, Rdy Process Name (PID), Rdy TID, AdjustReason, AdjustIncrement, CPU, InDPC

CSwitch, TimeStamp, New Process Name (PID), New TID, NPri, NQnt, TmSinceLast, WaitTime, Old Process Name (PID), Old TID, OPri, OQnt, OldState, Wait Reason, Swapable, InSwitchTime, CPU, IdealProc, OldRemQnt, NewPriDecr

Each trace consists of a series of events as in the examples above.

In order to make trace logs more manageable, the data in each trace may be partitioned into two parts, each of which may be stored or otherwise maintained in their own data structures such as files, databases, tables and the like. One part of the trace data is maintained in a data structure that will be referred to herein as a common knowledge dictionary (CKD). The CKD contains trace-independent data. That is, the CKD contains trace data that may be found in many traces and is not specific to only a single trace. Non-exhaustive examples of trace-independent data includes event names, process names associated with events, stack traces, file names or generic trace invariant primitives, all of which may be shared among multiple traces. None of the CKD data should carry a specific value that changes from trace to trace. Rather, such specific values which are trace-dependent referred to herein as trace instance information (TII), are included in their own data structure.

Trace instance information thus contains specifics of a trace instance. Non-exhaustive examples of trace instance information include process IDs (PIDs), thread IDs, timestamps, wait times, IO times and so on. The TII can be represented in an efficient manner by expressing individual TII records in terms of the entries in the CKD. Since in this way trace-independent data does not need to be included in each and every trace instance, redundancy in the trace data can reduced.

Further decreases in the amount of information that needs to be stored, and thus increases in efficiency, can be obtained by recognizing that when many traces are examined, various patterns emerge which are common to multiple traces. Such patterns may include, for instance, a particular sequence of events which recurs in multiple traces or a common value for a particular property in one event that is found in another event within the same trace. When a pattern or sequence is found in multiple traces, the portion of this pattern which is invariant to any trace instance can be stored in the CKD and the trace specific information associated with the pattern can be stored in the TII. In addition to identifying patterns in or among two or more events, patterns may also be found within individual events.

A concrete example of a pattern that may be found in multiple traces can be illustrated by referring to the two illustrative events shown above, the ReadyThread and CSwitch event. These two events are presented below with illustrative values for the various properties included in each event.

ReadyThread, 15965, lsass.exe (600), 616, System (4), 68, Unwait, 1, 0

CSwitch, 15970, System (4), 68, 13, −1, 52, 0, Idle (0), 0, 16, −1, Running, WrCallbackStack, NonSwap, 52, 1, 1, 0, 0, 0

As shown, the value for the Rdy TID in the ReadyThread event, which is 68, matches the value for the NEW TID in the subsequent CSwitch event. This pattern or sequence may be found to occur frequently in other traces. Given this pattern, the CKD record and its corresponding TII record may be formulated as follows. First, a name is assigned to the pair of events. For instance, in this example the pair of events may be designated “ReadyCSwitchPair.” Next, a CKD record name is assigned to this pattern, which is used to locate the entry for the pattern in the CKD. In this particular example the name of the CKD record assigned to the pattern “ReadyCSwitchPair” is CommonUniqueId. The complete CKD record may then be written as follows:
CommonUniqueId, ReadyCSwitchPair, lsass.exe, System

In addition to the CKD record name and the event pair name, the CKD record includes the PID value for the first ReadyThread event (Isass.exe) and the PID value for the CSwitch event (System). In this way the pattern is uniquely defined in the CKD, yet does not contain trace instance information.

The corresponding entry for this pattern in the TII is also designated with a name or identifier. In this particular example the TII instance information for the pair of events is assigned the name SomeID. This name may be placed in one of the fields of the TII record. The second field in the TII record may reference the corresponding CKD record in the CKD. At this point, the TII record in this example is:
SomeId, CommonUniqueId

Beyond these two entries, the TII may include any trace-specific data that is desired which pertains to the other properties of the two events specified by the TII record. For example, it will often be desired to include the time at which each event occurred within the thread described by the trace. One convenient and compact way to include this information is to express the TII record as follows:
SomeId, CommonUniqueId, 15965, 5, 52, 68

In this record the entry “15965” denotes the time at which the first event (ReadyThread) took place, the entry “5” denotes the interval between the timestamp of the first event and timestamp of the second event (CSwitch) and the entry “52” is the value for the TmSinceLast field, which represents the interval in microseconds since that system thread was last running Given the single TII record shown above, along with access to the CKD, the following underlined fields in the ReadyThread and CSwitch events can be recreated:

ReadyThread, 15965, lsass.exe (600), 616, System (4), 68, Unwait, 1, 0 CSwitch, 15970, System (4), 68, 13, −1, 52, 0, Idle (0), 0, 16, −1, Running, WrCallbackStack, NonSwap, 52, 1, 1, 0, 0, 0

Of course, the CKD and/or TII record may include values for additional fields if their recovery is desired. For example, the following CKD record, which is denoted CommonUniqueIdEx1 to distinguish it from the previous CKD record, will allow several additional fields to be recovered:

CommonUniqueIdEx1, ReadyCSwitchPair, lsass.exe, System, Unwait, Running, WrCallbackStack, NonSwap

The corresponding TII record is then:
SomeId, CommonUniqueIdEx1, 15965, 5, 52

Given these records, the following underlined fields in the ReadyThread and CSwitch events can now be recreated:

ReadyThread, 15965, lsass.exe (600), 616, System (4), 68, Unwait, 1, 0,

CSwitch, 15970, System (4), 68, 13, −1, 52, 0, Idle (0), 0, 16, −1, Running, WrCallbackStack, NonSwap, 52, 1, 1, 0, 0, 0

It should be noted that the aforementioned examples are presented for illustrative purposes only to facilitate an understanding of the principles of the invention. The actual schema and data classification that is used may vary from application to application and can be tailored for the type of data that is being stored.

Due to the nature of traces, and the similarities between traces captured from multiple systems, the size of the CKD typically will grow faster at the beginning when it is first established. The growth of the CKD will generally slow down asymptotically as the number of traces it incorporates increases, as common patterns/constructs are likely to have already been identified from previously obtained traces. As a result the storage cost per trace in the TII will become incrementally smaller over time. If further filtering is applied to achieve noise reduction the cost per unit storage and the access time can be improved even more.

By storing trace patterns which only include a subset of the information from the actual traces, the process of sharing the traces with other clients/customers can be simplified. Such simplification can occur because of the reduced bandwidth that is needed as a result of the reduced amount of information being transferred and also because irrelevant events that are unlikely to be pertinent to any given problem are eliminated.

One consequence that arises from partitioning trace data between the CKD and the TII is that the TII information is meaningless in the absence of the CKD. This architecture may provide a way to address privacy issues by filtering out certain information before sharing trace information with others. For instance, assume in one implementation that the CKD is materialized in a SQL database, as is the TII. If this information needs to be shared with third parties, translation tables can be used for the items in the CKD, which is specific to the application or third party.

If it is desired to materialize an event from a trace, some of the CKD entries will have to be referenced. However, some of the entries may be marked as “sensitive for sharing”. Based upon the nature of the query, its purpose, and so on, the values from the CKD table may not be made directly accessible. Rather, an intermediary translation table may be employed. The table may use a different translation for each entry in the CKD. The table may indicate that the reference used in the TII for the value of a given entry in the CKD may be the same as the original value (i.e., the original value in the CKD record is used directly in the TII). Alternatively, the table may scramble or otherwise replace the value of a given entry in the CKD. That is, a local, unique identifier may be assigned to the value which is consistent across the trace or traces being exported. In this way the value of an item such as a user, computer or domain name can be replaced and the presence of other information such as a competing product can be eliminated. In yet another approach, the value of a given entry in the CKD may be hidden or replaced with a predefined “unknown” value, which indicates that they do not map to the same initial value. For instance, when hiding private symbols in stacks, their values can all be represented as “unknown,” thereby avoiding the inference that they all represent the very same function in all cases.

Depending upon the implementation, it is also possible to leverage the split between the CKD and TII to identify potential entries that raise privacy concerns. If, for instance a particular entry is referenced by a small number of distinct trace entries in the TII, this entry can be automatically hidden/scrambled/replaced with a generic entry.

It should be noted that the use herein of the term “table” is used in its broadest sense to represent any way in which the translation function may be accomplished. For instance, the translation table may be implemented as a service, a stored procedure, and so on.

The systems and techniques described above for partitioning trace data can not only reduce the average cost per trace in terms of storage space for large volume of traces, but also provides quicker access to a large collection of traces, which may facilitate a more meaningful analysis of the data, particularly when leveraging database analysis technologies such as OLAP and modeling. However as the subject machine changes over time, and older symbols/values become irrelevant (e.g., because of recent service packs, patches or newly released products), the overall mechanism described herein maintains a good understanding of the current usage of the CKD entries. However, as the TII data ages and is archived or deleted, some entries in CKD may become “orphaned” as no references to them no longer exist in the TII.

As TII data is discarded, a maintenance task can scan the CKD for entries no longer referenced, and these entries can be deleted archived or otherwise removed from the CKD. Alternatively a reference counter can be associated with each entry in the CKD. This approach may require additional overhead to maintain the counter and it may pose some concurrency issues as well. Nevertheless, an entry removal mechanism or an active reference counting scheme may be are appropriate for certain applications.

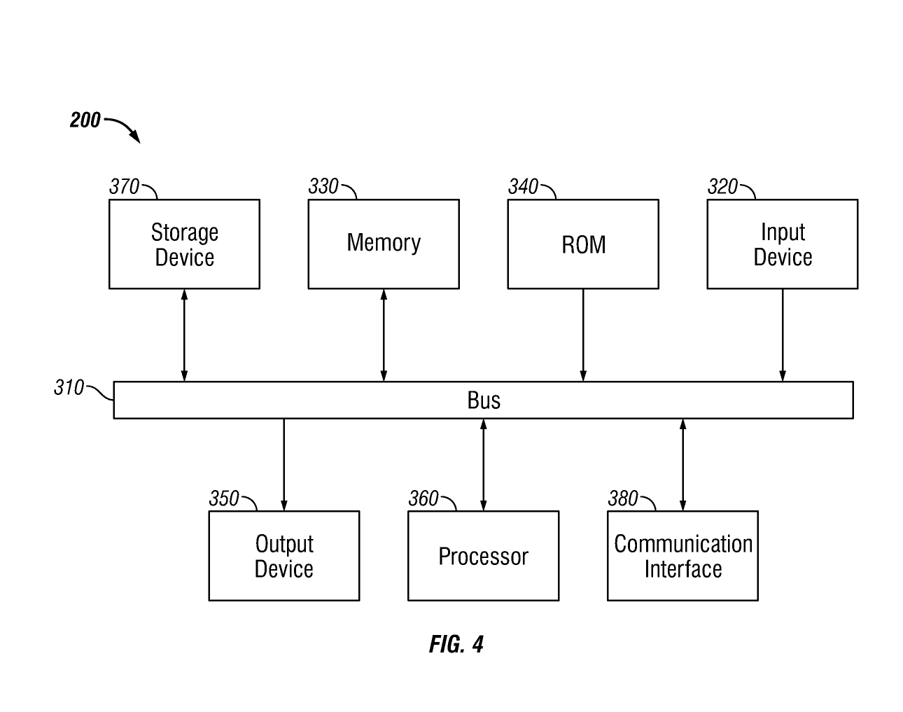

FIG. 4 is a simplified functional block diagram of an illustrative computing platform or other electronic device such as subject machine 402 and/or a diagnostic system incorporating the event tracing component 400 (FIG. 1). The server 200 is configured with a variety of components including a bus 310, an input device 320, a memory 330, a read only memory (“ROM”) 340, an output device 350, a processor 360, a storage device 370, and a communication interface 380. Bus 310 will typically permit communication among the components of the server 200.

Processor 360 may include at least one conventional processor or microprocessor that interprets and executes instructions. Memory 330 may be a random access memory (“RAM”) or another type of dynamic storage device that stores information and instructions for execution by processor 360. Memory 330 may also store temporary variables or other intermediate information used during execution of instructions by processor 360. ROM 340 may include a conventional ROM device or another type of static storage device that stores static information and instructions for processor 360. Storage device 370 may include compact disc (“CD”), digital versatile disc (“DVD”), a magnetic medium, or other type of computer-readable storage device for storing data and/or instructions for processor 360.

Input device 320 may include a keyboard, a pointing device, or other input device. Output device 350 may include one or more conventional mechanisms that output information, including one or more display monitors, or other output devices. Communication interface 380 may include a transceiver for communicating via one or more networks via a wired, wireless, fiber optic, or other connection.

The server 200 may perform such functions in response to processor 360 executing sequences of instructions contained in a tangible computer-readable medium, such as, for example, memory 330, ROM 340, storage device 370, or other medium. Such instructions may be read into memory 330 from another machine-readable medium or from a separate device via communication interface 380.

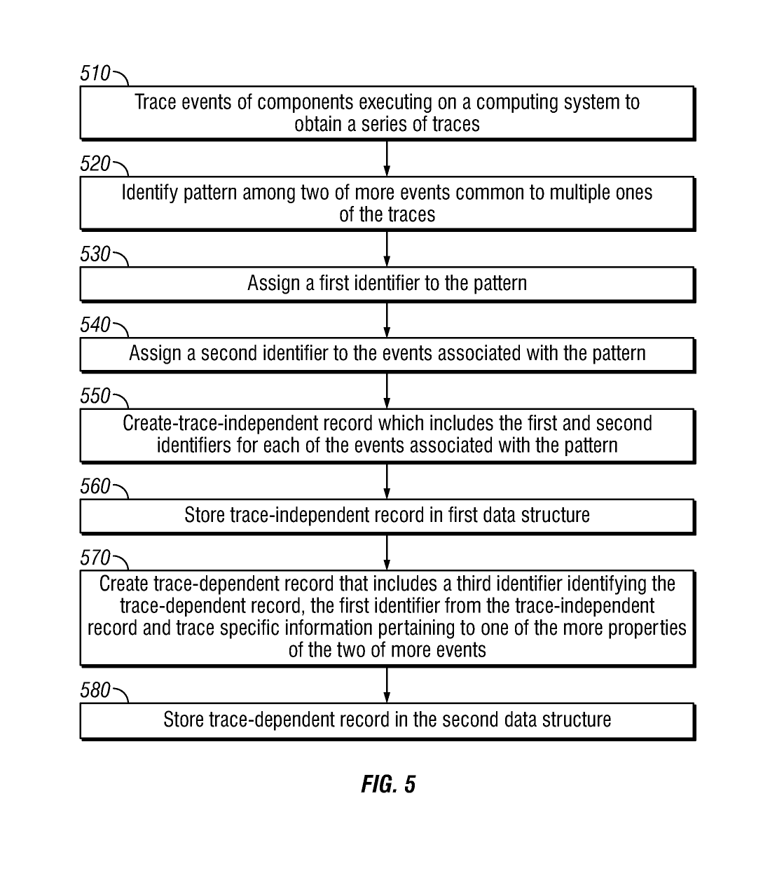

FIG. 5 is flowchart showing one example of a method for creating and storing trace data. The method begins at step 510 by tracing events of components executing on a computing system to obtain a series of traces. In step 520 a pattern is identified among two or more events that is common to multiple ones of the traces. Next, information associated with the pattern which is invariant to any trace instance is stored in a first data structure. This may be accomplished by first assigning in step 530 a first identifier to the pattern and assigning in step 540 a second identifier to the events associated with the pattern. A trace-independent record is created in step 550 which includes the first identifier, the second identifier and a PID value for each of the events associated with the pattern. The first identifier can serve as an entry to locate the trace-independent record in the first data structure. The trace-independent record is stored in the first data structure at step 560.

After storing the trace-invariant information, information associated with the pattern which is trace specific is stored in a second data structure. This may be accomplished by first creating at step 570 a trace-dependent record that may optionally include a third identifier identifying the trace-dependent record, the first identifier from the trace-independent record as well as trace specific information pertaining to one of the more properties of the two or more events. Finally, at step 580 the trace-dependent record is stored in the second data structure.

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable storage medium embedded with a computer executable program, which encompasses a computer program accessible from any computer-readable storage device or storage media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method of creating and storing trace data, comprising:
tracing events of components executing on a computing system to obtain at least one trace;
partitioning data in the trace into a first trace independent component which includes trace-independent information and a second trace dependent component which includes trace instance information; and
storing the first trace independent component in a first data structure and the second trace dependent component in a second data structure, wherein the second trace-dependent component includes a reference to an entry in the first data structure.

2. The method of claim 1 in which the trace-independent information is selected from the group consisting of event names, process names associated with events, stack traces, file names and generic trace invariant primitives.

3. The method of claim 1 in which the trace instance information is selected from the group consisting of process IDs (PIDs), thread IDs, timestamps, wait times and JO times.

4. The method of claim 1 in which tracing the events is performed by an operating system operating on the computing system.

5. The method of claim 1 further comprising:
identifying a pattern arising in or among one or more events that is common to multiple traces;
storing information associated with the pattern which is invariant to any trace instance in the first data structure; and
storing information associated with the pattern which is trace-specific in the second data structure.

6. The method of claim 5 in which storing information associated with the pattern which is invariant to any trace instance further comprises:
assigning a first identifier to the pattern and assigning a second identifier to the events associated with the pattern;
creating a trace-independent record that includes the first and second identifiers for each of the events associated with the pattern, wherein the first identifier serves as an entry to locate the trace-independent record in the first data structure; and
storing the trace-independent record in the first data structure.

7. The method of claim 6 in which storing information associated with the pattern which is trace specific further comprises:
creating a trace-dependent record that includes a third identifier identifying the trace-dependent record, the first identifier from the trace-independent record and trace specific information pertaining to one of the more properties of the two or more events; and
storing the trace-dependent record in the second data structure.

8. The method of claim 5 in which the pattern includes a sequence of at least two events occurring in a single trace which have common values for one or more properties within each event.

9. The method of claim 1 in which the reference to the entry in the first data structure includes a value corresponding to the entry, said value being stored in a translation table relating the reference to the value such that the entry is not accessible to a third party having access to the first and second data structures without also having access to the translation table.

10. The method of claim 1 further comprising:
periodically scanning the first data structure to identify orphaned entries in the first data structure that are no longer referenced in the second data structure; and
deleting the orphaned entries from the first database.

11. A computer-readable storage medium comprising instructions that, when executed by a processor, cause the processor to perform acts comprising:
receiving a plurality of traces that each trace execution flows performed on a processor;
identifying a pattern that arises within two or more of the plurality of traces;
storing information associated with the pattern which is invariant to any trace instance in a first data structure; and
storing information associated with the pattern which is trace-specific in a second data structure.

12. The computer-readable storage medium of claim 11 in which the trace-specific information includes a reference to a selected portion of the information in the first data structure.

13. The computer-readable storage medium of claim 12 in which the selected portion of the information in the first data structure includes an identifier of a data record that represents information for the pattern in the first data structure.

14. The computer-readable storage medium of claim 12 in which the reference to the selected portion of the information in the first data structure is available from a translation table and not the first data structure.

15. The computer-readable storage medium of claim 11 in which each of the traces trace events executed on a processor and the pattern is a pattern arising in or among one or more events occurring in a single trace.

16. A diagnostic system, comprising:
one or more processors for executing machine-executable instructions;
one or more machine-readable storage media for storing the machine-executable instructions, the instructions including a plurality of traces, each of the tracing being a trace of events executing on a computing system; and
processing logic configured to partition data in the trace into a first trace independent component which includes trace-independent information and a second trace dependent component which includes trace instance information; and
a memory for storing the first trace independent component in a first data structure and the second trace dependent component in a second data structure.

17. The diagnostic system of claim 16 in which the second trace-dependent component includes a reference to an entry in the first data structure.

18. The diagnostic system of claim 16 in which the processing logic is further configured to:
identify a pattern arising in or among one or more events that is common to multiple traces;
store information associated with the pattern which is invariant to any trace instance in the first data structure; and
store information associated with the pattern which is trace-specific in the second data structure.

19. The diagnostic system of claim 18 in which the processing logic is further configured to:
assign a first identifier to the pattern and assigning a second identifier to the events associated with the pattern;
create a trace-independent record that includes the first identifier, the second identifier and a PID value for each of the events associated with the pattern, wherein the first identifier serves as an entry to locate the trace-independent record in the first data structure; and
store the trace-independent record in the first data structure.

20. The diagnostic system of claim 18 in which the pattern includes a sequence of at least two events occurring in a single trace which have common values for one or more properties within each event.
